(19) United States
(12) Patent Application Publication
(10) Pub. No.: US 2019/0246611 A1
(43) Pub. Date: Aug. 15, 2019

(54) BEEHIVE FRAME

(71) Applicant: CERACELL BEEKEEPING SUPPLIES (NZ) LIMITED, East Tamaki (NZ)

(72) Inventors: Harold Bruce CLOW, Drury (NZ); Thomas Lionel CLOW, Drury (NZ)

(21) Appl. No.: 16/270,005

(22) Filed: Feb. 7, 2019

(30) Foreign Application Priority Data
Feb. 9, 2018 (NZ) 739812

(51) Int. Cl. A01K 47/02

(52) U.S. Cl. CPC A01K 47/02

(57) ABSTRACT

A beehive frame contains a perimeter frame for supporting a foundation sheet. One or both sides of the perimeter framework is/are adapted to provide a foundation on which bees build honeycomb. In one embodiment, the perimeter frame contains apertures or depressions in one or both sides of the perimeter frame. The apertures or depressions each have a dimension similar to or the same as a dimension of a natural honeycomb cell, so that the side or sides of the frame provides a foundation for the bees to build honeycomb. The frame increases yield and is resistant to small hive beetles.

### CLAIM FOR PRIORITY

This application claims, under 35 USC 119, the benefit of New Zealand Patent Application No. 739812 filed on Feb. 9, 2018, the subject matter of which is incorporated herein in its entirety by reference.

### TECHNICAL FIELD

The invention relates to a frame for a beehive. In particular, the invention relates to a frame that is resistant to small hive beetles and/or a frame that increases yield.

### BACKGROUND

A typical beehive comprises a box, typically constructed of wood, and a number of movable honey frames housed within the box. The frames are arranged vertically and side-by-side and hold the honeycomb produced by the bee colony populating the hive. The movable frames allow the apiarist to remove individual frames from the hive, to harvest honey without killing the bees or damaging the hive, and to inspect for diseases and parasites. A single hive typically has a number of boxes in a stack, each box holding 8 to 12 frames, with a lid covering the uppermost box.

Frames were traditionally manufactured from timber. A timber frame consists of two side pieces or side bars, a top piece or top bar, and a bottom piece or bottom bar, joined together to form a rectangular framework. The top bar extends beyond the side bars to provide supports which rest on an upper edge of the box to support the framework vertically in the box. The framework supports a sheet (the foundation) on which the bees construct the honey comb within the frame. Wires may be strung between the side bars to support the sheet, and grooves may also be provided to an inside of the framework, e.g. the inside of the top bar and the bottom bar, to support edges of the foundation sheet. Traditionally a foundation sheet or plate of beeswax was used, with an imprinted comb pattern to encourage comb production. The bees produce comb on each side of the sheet within the inside perimeter of the framework. The comb on one side is produced to a height approximately equal to half the width of the framework. A correct frame width and spacing between frames within the hive is important to ensure comb does not cross over between adjacent frames, so that individual frames can be easy removed from the hive for inspection or harvest without destroying the comb. A frame spacing is chosen to maximize yield without comb crossing over between adjacent frames. Once a honey frame is removed from a hive, honey is typically harvested from the frame by placing the frame in a centrifuge. The framework and sheet are cleaned, any necessary maintenance carried out, and reused.

Plastic honey frames are becoming more common and have some benefits over traditional wooden frames. Plastic frames are cheaper than wooden frames, require no maintenance other than cleaning, and are typically more durable. An example plastic honey frame 1 is illustrated in FIG. 1. A plastic honey frame 1 is typically a unitary moulded component and includes a perimeter framework 2 and integral sheet 3 inside the framework located in the middle of the width of the framework 1. The perimeter framework 2 provides structure a support for the sheet and space for the comb to be produced. The illustrated perimeter framework 2 has an outer perimeter rib 4 and an inner perimeter rib 5, and cross ribs or members 6 between to form a structural framework 2 to resist bending or twisting of the honey frame 1. The sheet 3 has a honey comb pattern. Prior to use, the sheet 3 is coated with beeswax or other covering such as a sugar coating to encourage bees to build comb on the foundation sheet. The coating may be applied by the apiarist or by a manufacturer of the frame 1.

The apiarist is faced with a number of challenges in the production of honey. Once challenge is to maintain a healthy hive, by preventing or at least hindering the spread of disease or pests through a hive. Pests include the varroa mite, wax moths, and the small hive beetle. The small hive beetle originates from Africa, but has spread to many other locations, including North America and Australia, being discovered in these locations in the mid to late 1990's and early 2000's. There is concern in the bee keeping community that the small hive beetle will arrive in other locations, including New Zealand. In Africa, the small hive beetle is not a significant honey bee pest, however, since arriving in other locations the beetle has caused a major impact to honey bee colonies. Female beetles lay eggs in cracks or crevices in a hive. The eggs hatch in 2-3 days into larvae. The larvae feed on pollen and honey, damaging combs. A heavy infestation can cause bees to abandon the hive. Beetles are typically found in the corners and edges of the honey frames within a hive. Worker bees fight off the beetle by corralling the beetles to edges of the honey comb, and restricting their movement by forming enclosures of propolis.

Various methods have been employed to control the small hive beetle, including control through the application of pesticides, and the use of beetle traps. The use of pesticides is unattractive for many beekeepers, and specific procedures often must be followed, for example application only at certain times and in correct doses, and care must be taken to ensure pesticides are not transferred to the bees. Traps are not always effective and/or require additional effort and expense. In-hive traps must be small to fit between frames, and therefore need to be emptied often. Traps often use oil in a bottom of the trap to kill the beetles, and filling the traps with oil can be messy.

It would be useful if there could be provided a means to assist in the control of beehive pests such as the small hive beetle. It would also be useful if there could be provided a means to increase the honey yield produced on a beehive honey frame.

It is an object of the present invention to address one or more of the foregoing problems, or at least provide the public with a useful choice.

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications are referred to herein, this reference does not constitute an admission that any of these documents form part of the common general knowledge in the art, in New Zealand or in any other country.

Throughout this specification, the word “comprise”, or variations thereof such as “comprises” or “comprising”, will be understood to imply the inclusion of a stated element, integer or step, or group of elements integers or steps, but not the exclusion of any other element, integer or step, or group of elements, integers or steps.

Further aspects and advantages of the present invention will become apparent from the ensuing description which is given by way of example only.

### SUMMARY

According to one aspect of the present invention there is provided a beehive honey frame comprising a perimeter framework to support a honeycomb foundation sheet within the perimeter framework, wherein the perimeter framework comprises a plurality of apertures or depressions on one or both side faces of the perimeter framework,
wherein each aperture or depression is sized to have a lateral dimension and area similar to or the same as a lateral dimension and area of a cell of a natural honeycomb.

Preferably the apertures or depressions each have a depth approximately equal to half a width of the perimeter framework minus half a thickness of a honeycomb foundation sheet.

Preferably the perimeter framework comprises said apertures or depressions in both side faces of the perimeter framework.

The apertures or depressions each have at least six sides, or are circular. Preferably the apertures or depressions each have six sides to approximately replicate the shape of a natural honeycomb cell.

Preferably the beehive honey frame comprises a foundation sheet located within and supported by the perimeter framework. Preferably the foundation sheet is integrally formed with the perimeter framework. Preferably the beehive honey frame is a unitary moulded component. Preferably the foundation sheet comprises a honeycomb pattern of apertures or depressions, and wherein the apertures or depressions on the side face(s) of the perimeter framework are deeper than the apertures or depressions of the honeycomb pattern on the foundation sheet. Preferably the apertures or depressions on the side face(s) of the perimeter framework are sized to have a lateral dimension and area similar to or the same as a lateral dimension and area of the apertures and depressions of the honeycomb pattern on the foundation sheet.

Preferably the beehive honey frame comprises a foundation coating on the side face or side faces of the perimeter framework to coat an inner surface of the apertures or depressions.

Preferably the beehive honey frame has the apertures or depressions around a full perimeter of the perimeter framework.

Preferably the beehive honey frame comprises an array or at least one row of said apertures or depressions in one or both side faces of the perimeter framework.

According to another aspect of the present invention there is provided a beehive honey frame comprising a perimeter framework to support a foundation sheet within the framework, wherein one or both side faces of the perimeter framework replicate a honeycomb pattern (i.e. a cellular arrangement). This aspect of the invention may comprise any one or more of the features described above in relation to the first aspect.

Disclose the invention, as claimed, in such terms that the technical problem (even if not expressly stated as such) and its solution can be understood, and state the advantageous effects, if any, of the invention with reference to the background art.

### BRIEF DESCRIPTION OF THE DRAWINGS

Further aspects of the present invention will become apparent from the ensuing description which is given by way of example only and with reference to the accompanying drawings in which:

FIG. 1 illustrates a prior art plastic bee frame.

FIGS. 2A to 2C illustrate a plastic bee frame according to the present invention. FIG. 2A is a side view, FIG. 2B is an end view, and FIG. 2C is a bottom view.

FIGS. 3A and 3B provide enlarged views of the areas marked B and D in FIG. 2A.

FIGS. 4A and 4B provide sectional views of the frame of FIGS. 2A to 2C. FIG. 4A is a sectional view on line A-A in FIG. 2A, and FIG. 4B is a sectional view on line C-C in FIG. 2A.

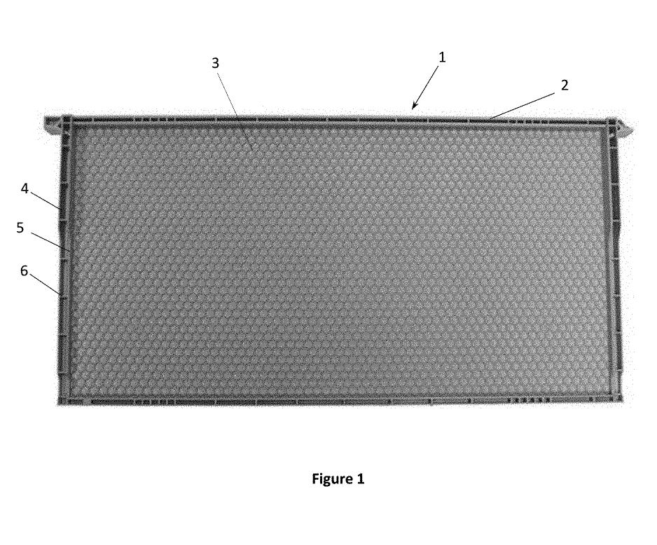

### DETAILED DESCRIPTION

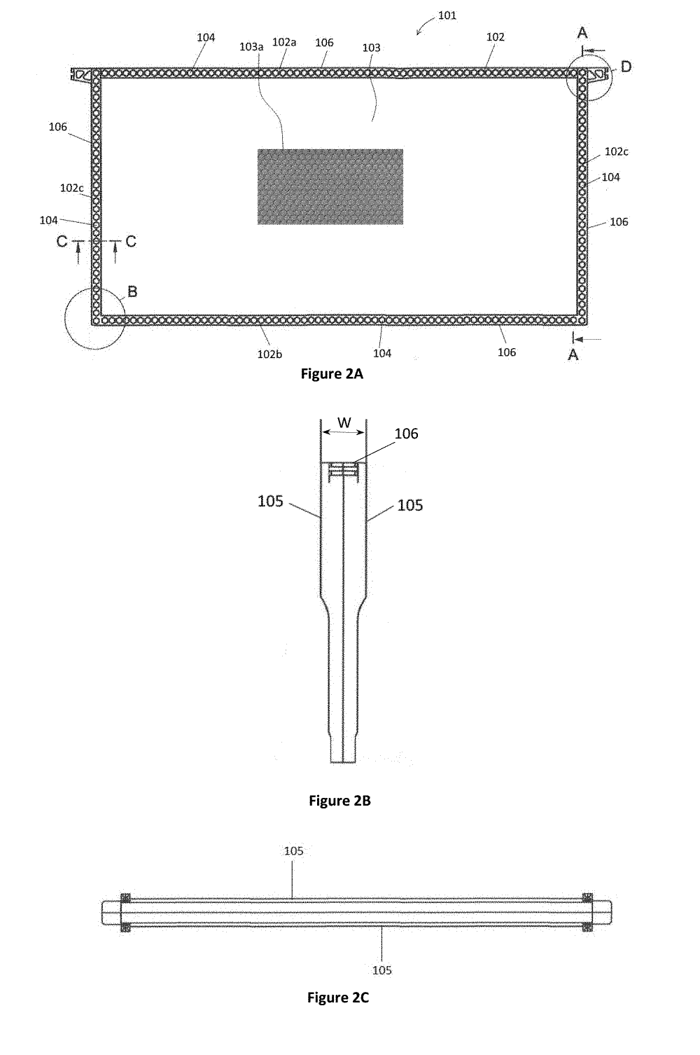

A beehive honey frame according to the present invention is illustrated in FIGS. 2A to 2C. The frame 101 comprises a perimeter framework 102, the perimeter framework 102 having a top bar 102a, a bottom bar 102b and opposed side bars 102c. The perimeter framework 102 is rectangular. The perimeter frame 102 supports a foundation sheet or plate 103 within the perimeter framework on which the bees of a hive build a honey comb. The illustrated frame 101 is a unitary moulded plastic component comprising the perimeter framework 102 and an integral foundation sheet 103 inside the perimeter framework. However, the present invention may consist in a beehive honey frame comprising a perimeter framework 102 without an integrally formed foundation sheet 103.

The foundation sheet 103 preferably has a honey comb pattern. The illustrated embodiment shows the honeycomb pattern on a portion of the sheet only, however preferably the honeycomb pattern covers the full surface of the sheet 103 on both sides, as known in the art. A plastic foundation sheet is coated with beeswax or other covering such as a sugar coating to encourage bees to build honeycomb on the sheet 103.

According to the present invention, one or both side faces of the perimeter framework 102 is/are adapted to provide a foundation on which bees build honeycomb. For example, a coating may be provided to the side faces of the perimeter framework, wherein the coating encourages bees to build honeycomb on the side faces of the perimeter framework. The coating may for example be beeswax.

In the preferred illustrated embodiment, the perimeter framework comprises apertures or depressions 104 in the side faces 105 of the perimeter framework to encourage bees to build honeycomb on the side faces of the perimeter framework. Preferably the perimeter 102 framework has apertures or depressions 104 on both side faces, however apertures or depressions 104 may be provided to one side face of the perimeter framework.

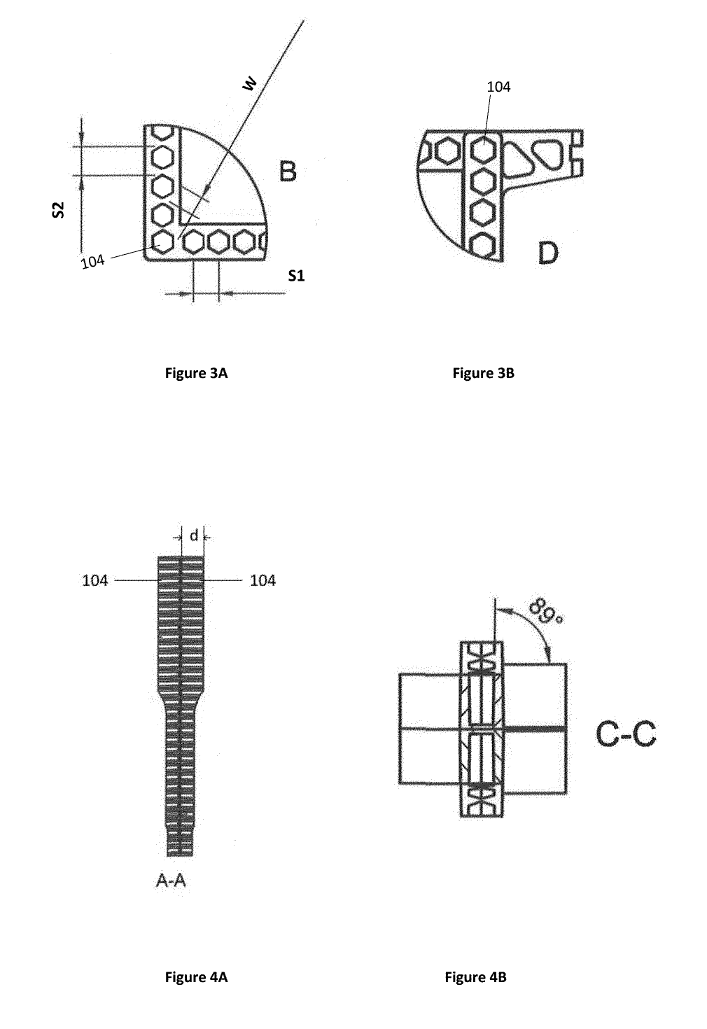

The apertures or depressions 104 each have a lateral dimension and area similar to or the same as a lateral dimension and area of a typical cell of a honeycomb, to encourage comb production. For example, the apertures or depressions 104 each have substantially the same lateral dimension (e.g. width ‘w’ in FIG. 3A) as each aperture or depression of the honeycomb pattern formed on the sheet 103. A typical bee honeycomb cell has six sides with a lateral dimension or width of about 5 mm across opposed sides of the cell. A cell may have a lateral dimension of about 4.5 mm to 5.5 mm across opposed sides of the cell. Thus, the apertures or depressions 104 in the side 105 of the perimeter framework preferably each have a lateral dimension or width ‘w’ of about 4.5 mm to 5.5 mm. For a regular hexagonal shaped aperture, a width across opposed sides of the aperture of 4.5 mm to 5.5 mm corresponds to an area of about 17 to 26 mm². The apertures or depressions preferably have six sides, e.g. are approximately hexagonal, to replicate a sixed sided natural bee cell, but may be circular, or have less than six sides or more than six sides. More than five sides are preferred. Where the aperture or depression has five or more sides preferably the aperture or depression is a regular polygon. A circular aperture or depression may have a diameter (lateral dimension) of about 4.5 mm to 6.5 mm, with a corresponding area of about 16 to 32 mm², to be about the same size as a cell of a honeycomb.

The apertures or depressions 104 have a depth 106 in a width direction of the frame 101. The width direction of the frame 101 is indicated by the width dimension ‘W’ FIG. 2B. The depth (‘d’ in FIG. 4A) of the apertures or depressions 104 is preferably approximately equal to the distance from the foundation sheet 103 to the side face 105 of the perimeter framework 102. For a top bar 102a width (W in FIG. 2B) of 35 mm and a foundation plate 103 thickness of 1.8 mm, the depth ‘d’ of the apertures or depressions 104 in the side face 105 of the top bar 102a will be about 16.6 mm. For a plastic moulded frame 101, preferable the apertures or depressions 104 have a slight taper as shown in FIG. 4B, so that an inner end or base of the depression or aperture 104 is slightly smaller than an outer end of the depression or aperture. The taper assists in manufacture to remove the frame 101 from a mould. The apertures or depressions 104 are preferably deeper than the apertures or depressions 103a formed on the sides of the foundation plate 103. The apertures or depressions 103a formed on the foundation plate may have a depth of about 1 mm to 2 mm. The thickness of the foundation plate is substantially less than the width W of the perimeter framework.

Preferably the beehive honey frame 101 has the apertures or depressions 104 around a full perimeter of the perimeter framework 102, as shown in FIG. 2A. However, in some embodiments the beehive honey frame 101 may have the apertures or depressions 104 along the side faces of the top bar 102a, or the bottom bar 102b, or one or both side bars 102c. The spacing between adjacent apertures or depressions 104 may be the same as or similar to the spacing between cells in natural honeycomb. The material of the perimeter framework 102 between adjacent apertures or depressions 104 forms strengthening ribs, so that the perimeter framework with apertures or depressions forms a structural member of the beehive honey frame 101 to prevent the beehive honey frame 101 from twisting or bending. In some embodiments, the material between adjacent apertures or depressions has thickness of about 1-2 mm. In the illustrated embodiment, the apertures or depressions 104 have a lateral dimension ‘w’ of 4.8 mm, and a centre-to-centre spacing with adjacent apertures or depressions arranged side-by-side (‘s1’ in FIG. 3A) of about 6.4 mm, resulting in a material or rib thickness between adjacent apertures or depressions of about 1.4 mm. In the illustrated embodiment, the apertures or depressions 104 in the side faces of the side bars 102c are arranged corner-to-corner, with a centre-to-centre spacing (‘s2’ in FIG. 3A) of about 7.15 mm, resulting in a material or rib thickness between adjacent apertures or depressions of about 1.4 mm. In the illustrated embodiment, the beehive honey frame 101 has a single row of apertures or depressions 104 in the side faces 105 of the perimeter framework 102. The row of apertures provides an array to replicate a portion of a natural honeycomb pattern (i.e. a cellular arrangement). In some embodiments, the beehive honey frame 101 may have more than one row of apertures or depressions in a side face or side faces of the perimeter framework 102.

Prior to use, bees wax or other foundation coating is preferably applied to the side face or side faces 105 of the perimeter framework 102, to coat inner surfaces of the apertures or depressions 104, to encourage bees to build comb in the apertures or depressions 104 on the side faces 105 of the perimeter framework 102. Preferably the foundation coating is applied to the side faces 105 of the perimeter framework 102 at the same time a foundation coating is applied to the sides of the foundation plate 103.

Providing comb sized apertures or depressions 104 on the side faces 105 of the perimeter encourage bees to build comb on the side faces of the perimeter framework so that the honey comb covers the side faces of the frame out to an outer perimeter edge 106 of the beehive honey frame 101. This result has two significant benefits. Firstly, hive yield is increased since the productive surface area of a beehive honey frame 101 is increased from being the area of the sides of foundation plate 103 within the perimeter framework 102, to be the area of the sides of the foundation plate 103 and additionally the area of the side faces 105 of the perimeter framework 102. The improved beehive honey frame increases revenue per frame. Secondly, by causing the bees to cover side faces 105 of the perimeter framework 102 with honeycomb, the hive becomes more resistant to small hive beetles. By building honeycomb to the outer edges 106 of the frame 101, bee activity is present at the frame 101 outer edges 106, giving the bees a higher chance of fighting/corralling beetles at the edge of the beehive honey frame 101 or otherwise reducing the chance of beetles travelling further inboard on the beehive honey frame 101.

The present invention may be used together with other known pest control means, such as traps. In-hive traps are necessarily small and therefore require frequent emptying. The present invention assists in the control of beetles, and therefore if used together with traps reduces the frequency in which traps must be cleaned, and refilled with oil if oil is used.

The invention may also be said broadly to consist in the parts, elements and features referred to or indicated in the specification of the application, individually or collectively, in any or all combinations of two or more of said parts, elements or features.

Aspects of the present invention have been described by way of example only and it should be appreciated that modifications and additions may be made thereto without departing from the scope thereof as defined in the appended claims.

What we claim is:

1. A beehive honey frame comprising: a perimeter framework to support a foundation sheet within the perimeter framework; wherein the perimeter framework comprises a plurality of apertures or depressions on one or both side faces of the perimeter framework; and
wherein each aperture or depression is sized to have a lateral dimension and area similar to or the same as a lateral dimension and area of a cell of a natural honeycomb.

2. The beehive honey frame as claimed in claim 1, wherein the apertures or depressions each have a depth approximately equal to half a width of the perimeter framework minus half a thickness of a honeycomb foundation sheet.

3. The beehive honey frame as claimed in claim 1, wherein the perimeter framework comprises said apertures or depressions in both side faces of the perimeter framework.

4. The beehive honey frame as claimed claim 1, wherein the apertures or depressions each have at least six sides, or wherein each aperture or depression is circular.

5. The beehive honey frame as claimed claim 1, wherein the apertures or depressions each have six sides to approximately replicate the shape of a natural honeycomb cell.

6. The beehive honey frame as claimed in claim 1, wherein the beehive honey frame comprises a foundation sheet located within and supported by the perimeter framework, and the foundation sheet comprises a honeycomb pattern of apertures or depressions, and wherein the apertures or depressions on the side face(s) of the perimeter framework are deeper than the apertures or depressions of the honeycomb pattern on the foundation sheet.

7. The beehive honey frame as claimed in claim 1, wherein the beehive honey frame comprises a foundation sheet located within and supported by the perimeter framework, and the foundation sheet comprises a honeycomb pattern of apertures or depressions, and wherein the apertures or depressions on the side face(s) of the perimeter framework are sized to have a lateral dimension and area similar to or the same as a lateral dimension and area of the apertures and depressions of the honeycomb pattern on the foundation sheet.

8. The beehive honey frame as claimed in claim 1, wherein the beehive honey frame has the apertures or depressions around a full perimeter of the perimeter framework.

9. The beehive honey frame as claimed in claim 1, wherein the beehive honey frame comprises an array or at least one row of said apertures or depressions in one or both side faces of the perimeter framework.

10. The beehive honey frame as claimed claim 1, wherein the beehive honey frame comprises a foundation sheet located within and supported by the perimeter framework.

11. The beehive honey frame as claimed in claim 10, wherein the foundation sheet is integrally formed with the perimeter framework.

12. The beehive honey frame as claimed in claim 11, wherein the beehive honey frame is a unitary moulded component.

13. The beehive honey frame as claimed in claim 1, wherein the beehive honey frame comprises a foundation coating on one or both side faces of the perimeter framework.
